(19) United States
(12) Patent Application Publication
(10) Pub. No.: US 2009/0188139 A1
(43) Pub. Date: Jul. 30, 2009

(54) Paperweight desk sign

(76) Inventor: Richard C. Rowley, Metairie, LA (US)

Correspondence Address: Richard Rowley, 418 North LaBarre Road, Metairie, LA, 70001, US

(21) Appl. No.: 12/011,765

(22) Filed: Jan. 30, 2008

(51) Int. Cl. B43M 9/00

(52) U.S. Cl. 40/358

(57) ABSTRACT

The object of this invention is to provide an improved paper weight or article of desk furniture which shall be useful not only as a paper weight, but for the purposes of alerting other visitors that they may or may not disturb the person at this desk or location.

This paperweight desk sign, being a 3-sided equilateral triangle, has 3 different front sides with wording on each of it's 3-sides informing others of the owner's mental temperament and/or intentions regarding if and how this sign's owner would or would not be disturbed by simply facing the desired wording (WELCOME, MAKE IT SHORT, or DO NOT DISTURB) in the direction of the visitor by turning the sign over.

### BACKGROUND OF THE INVENTION

This paperweight desk sign invention is related to name plates, and more particularly to a name plate in which a person's name is engraved on one surface.

### SUMMARY OF THE INVENTION

The broad purpose of the present invention is to provide office workers a way of letting other people know when they need not to be disturbed whatsoever or interrupted for only short phases like to answer a question, etc.

Office etiquette in most places, requires knocking at the office door and ask to enter, (this interrupt the worker in that office).

The visitor knocking has no way of knowing what the person in the office is engaged-in.

Scenario One: The occupant of an office could at the moment be on the phone (cell phone, etc.) or using a calculator or perhaps having moments where-as their complete concentration is needed and now they find themselves completely interrupted by their new visitor.

Having this invention on their desk within arm's reach, they can turn this paperweight desk sign over to reveal what they want from their new visitor, which should help minimize most interruptions.

This office scenario is only an example. This invention can also be used (not only in an office setting), but were ever someone needs to alert others that they no not want to be disturbed.

### DESCRIPTION OF THE DRAWING

The description refers to the accompanying sketches in which like reference characters refer to like parts throughout the several views, and in which:

FIG. 1 is a FRONT view of this invention, illustrating the preferred embodiment of the invention; Side 1: the wording “WELCOME” is in full view for a visitor to see.

FIG. 2 is also a FRONT view of this invention, illustrating another preferred embodiment of the invention; Side 2: the wording “MAKE IT SHORT” is in full view for a visitor to see.

FIG. 3 is also a FRONT view of this invention, illustrating another preferred embodiment of the invention; Side 2: the wording “DO NOT DISTURB” is in full view for a visitor to see.

FIG. 4 shows an end view of this invention. The other end is identical to this one.

FIG. 5 is an isometric view showing Side 1 as being the front view and also showing it's overall approximate dimensions: 9½″ to 10″ wide and all sides of it's triangular end width could be approximately 2″.

These dimensions can vary and are shown only to give this reader an approximately idea of the sign's overall size.

FIG. 6 is an isometric view showing Side 2 as being the front view.

FIG. 7 an isometric view showing Side 3 as being the front view.

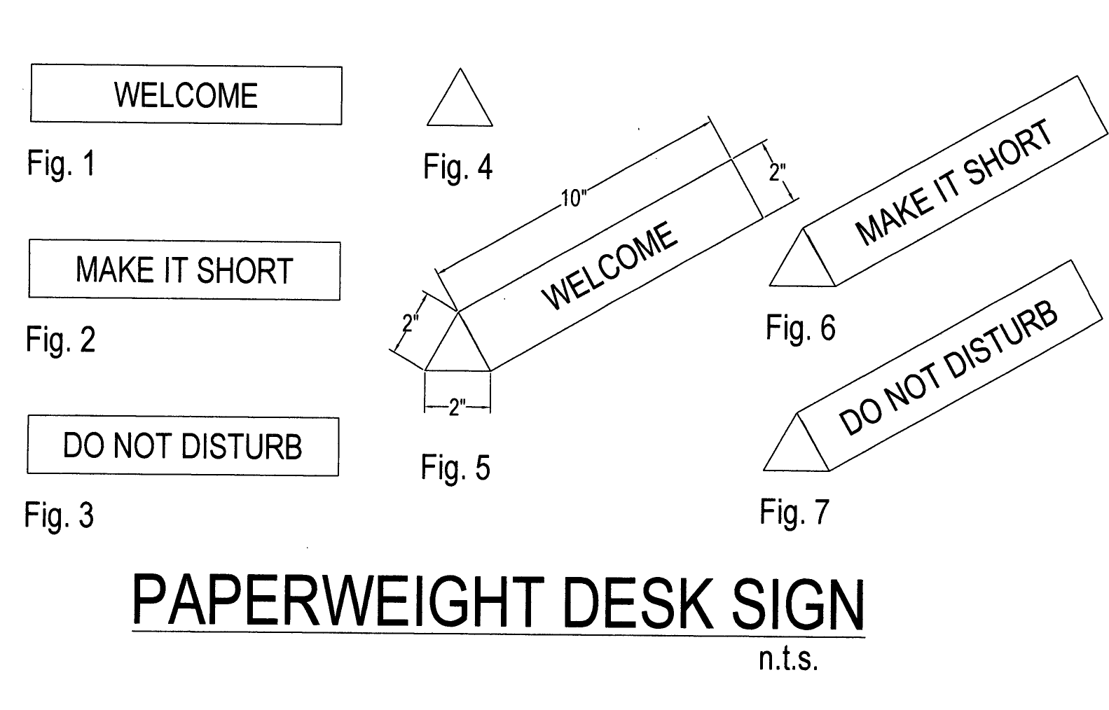

### DESCRIPTION OF THE PREFERRED EMBODIMENT

Referring to the drawing, a preferred paperweight (name plate) desksign, comprises a triangle configuration with each front side having different wording to indicate the user's mental temperament and/or intentions at that moment.

This object could be constructed of almost anything: wood, plastic, glass, ceramics, etc. and lettering fonts or background could have coloring to match wording.

### Example One

“WELCOME”: green; “MAKE IT SHORT”: yellow; “DO NOT DISTURB”: red Wording could be painted, etched, recessed, raised and font style such as “Arial narrow” or any size or font type that fits in allowed space of each front view.

### Example Two

“SMILLE”: green; “CAUTION”: yellow; “GO AWAY”: red. In other words, each side's wording and color would indicate the temperament of it's owner (user) to inform a possible visitor if it's ok to interrupt or be welcome to visit at that present time.

Other words like “Irritable”, “grouchy” or short wording could also be used such as “bad mood”, etc. . . . along with related colors.

Mass production of this invention: If made from plastic, molds would be created and then invention could be manufactured using whatever reproduction process desired: Sand casting; Rapid injection molding; Vacuum form; Pressure form; Thermoform, etc.

Mass production of wooden or metal paperweights could be done using a CNC router and/or a CNC machinery process.

process.

Being a (3) sided equilateral triangle, some reproduction processes such as for ceramics, may require an additional mold and then production pieces would be glued or bonded into one piece.

### REFERENCES CITED

### U.S. Patent Documents

| | | |
|---|---|---|
| 3364603 | Jan. 1, 1968 | Tate |
| D354774 | Jun. 19, 1962 | Orsus, Nicholas |

Having described my invention, I claim:

1. A paperweight desk sign, comprising:
of a 3-sided equilateral triangle (sides referred to as “Side 1, Side 2, and Side 3”) approximately 2″ in width and 9½″ long in length which displays the temperament wording (in reference to being disturbed): Side 1: WELCOME, Side 2: MAKE IT SHORT, Side 3: DO NOT DISTURB.
In addition to being an attractive paper weight the operation of this invention would be under the control of it's owner by placing it an obvious place on their desk so as to alert other visiting office workers, etc. of the importance of disruptions.
